(19) United States
(12) Patent Application Publication
(10) Pub. No.: US 2026/0361597 A1
(43) Pub. Date: Nov. 12, 2026

(54) METHOD AND APPARATUS FOR CONTROLLING USER TRAFFIC WITH A DIGITAL USER

(71) Applicant: Huawei Technologies Co., Ltd., Shenzhen (CN)

(72) Inventors: Mohamed Faraj Moftah Alzenad, Ottawa (CA); Nimal Gamini Senarath, Ottawa (CA)

(21) Appl. No.: 19/648,829

(22) Filed: Apr. 15, 2026

Related U.S. Application Data
(63) Continuation of application No. PCT/CN2024/091253, filed on May 6, 2024.
(60) Provisional application No. 63/591,313, filed on Oct. 18, 2023.

(51) Int. Cl. H04L 41/0803; H04L 65/1101

(52) U.S. Cl. CPC H04L 41/0803; H04L 65/1101

(57) ABSTRACT

A method and an apparatus for controlling user traffic using a digital user are provided. A digital user resides on the network on behalf of a physical user in order to provide enhanced functionality. Upon request of a physical user, a network session is established whereby data gateways and network functions are configured at least in part by the digital user. The digital user may set parameters for the data gateways and the network functions at least in part from network policies, network state information, and the digital user’s own policies.

### CROSS-REFERENCE TO RELATED APPLICATIONS

This application is a continuation of International Patent Application No. PCT/CN2024/091253, filed on May 06, 2024, which claims the benefits of U.S. Provisional Application No. 63/591,313, filed on Oct. 18, 2023, the disclosures of which are hereby incorporated by reference in their entireties.

### TECHNICAL FIELD

The present disclosure relates to wireless communications. Specifically, the present disclosure relates to a method and apparatus for controlling user traffic using a digital user.

### BACKGROUND

The design of 6G or future wireless networks should seek to accommodate multiple emerging technologies and trends, such as new network infrastructures, such as a native cloud infrastructure, technologies such as Artificial Intelligence (AI) and Blockchain, new apps and services, such as AI services and Data sensing services, and more open and collaborative operation modes.

Other requirements for future networks include increased privacy and trustworthiness, simplified standardization, rapid deployment, and support for Anything as A Service (XaaS).

Moreover, the 6G system network architecture should support 6G services developed by third parties by providing an open ecosystem, and enable improved trustworthiness management.

### SUMMARY

It is an object of the present disclosure to provide a digital user architecture for wireless communications.

In a first aspect, there is provided a method at a network element of a network, comprising receiving, from a user equipment (UE), a first request for establishing a user controlled and managed (UCM) service, wherein the UCM service allows the UE to control at least one feature of a UCM session of the UCM service using a control plane function of the UCM service; retrieving a first policy for the UE from a policy function of the network, the first policy indicating network requirements for controlling the at least one feature of the UCM service; sending a second request to a digital user (D-User), the second request being based on the first policy, wherein the D-User is a digital representative of the UE hosted by the network; receiving from the D-User session parameters, wherein the session parameters are based on the second request and a policy function of the D-User; and configuring a network function based on the session parameters, the network function comprising at least one of a network feature exposure function (NFEF), a data processing function (DPF), a user plane function (UPF), and a data gateway.

According to an embodiment of the first aspect, the configuring comprises providing the session parameters to a second network element. The second network element may use the session parameters to configure a network function.

According to another embodiment of the first aspect, the configuring comprises providing the session parameters to the NFEF, wherein the NFEF translates the session parameters to parameters understandable by a second network element responsible for managing the at least one feature of the UCM service. The NFEF may be used to translate the session parameters for the second network element.

According to yet another embodiment of the first aspect, the at least one feature of the UCM service comprises traffic management.

According to yet another embodiment of the first aspect, the at least one feature comprises one of selecting a low power channel, selecting a low interference channel, providing a high priority channel, or applying Multiple-Input Multiple Output.

According to yet another embodiment of the first aspect, the network is one of a Radio Access Network (RAN), a Core Network (CN), a Transport Network (TN), or a Data Network (DN).

According to yet another embodiment of the first aspect, the session parameters comprise at least one of traffic routing information for the data gateway, packet filtering rules, packet buffering rules, packet priority, packet inspection rules, and packet redirection rules and the network function comprises at least one of the DPF, the UPF, and the data gateway.

According to yet another embodiment of the first aspect, the session parameters are selected to be applied to different nodes of the network.

According to yet another embodiment of the first aspect, the first request comprises at least one of a UE identifier, a D-User identifier, a UCM service identifier, and a data gateway identifier.

According to yet another embodiment of the first aspect, the first policy comprises at least one of packet forwarding rules, packet inspection rules, Quality of Service (QoS) handling, data processing rules, reporting rules, network feature selection rules, and billing rules.

According to yet another embodiment of the first aspect, the method further comprises, prior to receiving the session parameters, sending a third request to the NFEF for network state information, and receiving the network state information from the NFEF. The network state information may be used to better configure the network function.

According to yet another embodiment of the first aspect, the method further comprises upon said receiving the network state information, forwarding the network state information to the D-User.

According to yet another embodiment of the first aspect, the network state information comprises a level of network information exposure, the level of network information exposure comprising one of traffic path information, end-to-end path information, or abstracted virtual network topology.

According to yet another embodiment of the first aspect, the method further comprises sending, to the UE, a response to the first request, the response confirming establishment of the UCM session and comprising packet header formatting information. The packet header information is used by the UE to send data to be processed according to the session parameters.

According to yet another embodiment of the first aspect, the packet header information comprises at least one of a UCM session identifier, and a feature identifier.

According to yet another embodiment of the first aspect, the configuring comprises configuring the network function to divert UCM session traffic to a DPF of the D-User, wherein the DPF of the D-User is configured to process the UCM session traffic according to a D-User policy and a processing specification within packet headers of the UCM session traffic.

According to yet another embodiment of the first aspect, the configuring comprises configuring the network function to apply the at least one feature to UCM session traffic according to the session parameters.

According to yet another embodiment of the first aspect, the configuring comprises preparing the network function to apply the session parameters to the session traffic arriving at the network function.

According to a second aspect, there is provided a network element comprising one or more processors configured to implement the method of any embodiment of the first aspect. In one embodiment, the network element comprises one or more processors, and a memory having instructions stored thereon which, when executed by the one or more processors, cause the network element to implement the method of any embodiment of the first aspect.

According to a third aspect, there is provided computer readable medium having stored thereon computer readable instructions, which when executed by one or more processors, cause a device to perform the method of any embodiment of the first aspect.

### BRIEF DESCRIPTION OF THE DRAWINGS

The present disclosure will be better understood with reference to the drawings in which:

FIG. 1 is a graphical representation of a Digital User (D-User) according to at least one embodiment of the present disclosure.

FIG. 2 is a graphical representation of an architecture for a NET4DW according to at least one embodiment of the present disclosure.

FIG. 3 is a graphical representation of a networking environment according to at least one embodiment of the present disclosure.

FIG. 4 is a graphical representation of a communications system according to at least one embodiment of the present disclosure.

FIG. 5 is a graphical representation of an electronic device communicating with a base station according to at least one embodiment of the present disclosure.

FIG. 6 is a block diagram of a device according to at least one embodiment of the present disclosure.

FIG. 7 is a block diagram of a structure for a 6G system according to at least one embodiment of the present disclosure.

FIG. 8 is a block diagram of a D-User and a P-User interfacing with an enhanced connectivity service according to at least one embodiment of the present disclosure.

FIG. 9 is a graphical representation of multiple network paths between a P-User and a Data Network according to at least one embodiment of the present disclosure.

FIG. 10 is a flow diagram illustrating a method for controlling user traffic according to at least one embodiment of the present disclosure.

FIG. 11 is a flow diagram illustrating a method for configuring a D-User according to at least one embodiment of the present disclosure.

FIG. 12 is a flow diagram illustrating a method for configuring a data gateway and a Network Feature Exposure Function according to at least one embodiment of the present disclosure.

FIG. 13 is a block diagram of an exemplary device for implementing embodiments of the present disclosure.

### DETAILED DESCRIPTION

The present disclosure is directed to a method and apparatus for controlling user traffic using a digital user.

Future networks are expected to be more user centric and to improve a user’s experience by dynamically adapting itself to the user context and needs. As a non-limiting example, a network may manage its resources, topology, and policies, according to a user’s location, mobility, and QoS requirements.

Moreover, it is envisioned that future networks will be designed to give the user more control over the services provided by the network, and even control over some network features. Such services may be referred to as User Controlled and Managed (UCM) Services.

Some UCM services that may be provided include:

A user may define a service capability, i.e., a user may define what services the user needs rather than only selecting services provided by a network;

A user may manage and control behaviors and features of the services provided by the network;

Each user may be served by a specific part of the network (e.g., an exclusive logical slice) and exercise some control over that specific part of the network;

User context may be used to provide tailored services and dynamic network functionality;

User devices, including smart phones, drones, and the like, may become part of the network, acting as base stations, relays, applications servers, and the like; and

A user may provide services to the network such as Artificial Intelligence (AI) services, video services, and Base Station (BS) services, amongst others.

In order to support the provision of UCM services, a virtual representative of a Physical User (P-User), or of a User Equipment (UE) is provided. Throughout this disclosure, the terms P-User and User Equipment (UE) are used interchangeably. The virtual representative may be called a virtual UE (V-UE) or a digital user (D-User). The D-User provides functionalities and resources to assist the provision of UCM services, including the ability to interact closely with the network serving the physical user.

A more detailed description of a D-User and related aspects that may be used in conjunction with the present disclosure is found in commonly owned patent application PCT/CN2023/106032 entitled “METHOD, APPARATUS AND SYSTEM FOR A USER TO CONTROL NETWORK SERVICES BY A VIRTUAL USER EQUIPMENT,” which is incorporated herein by reference in its entirety.

A D-User may be installed in the network so that it may closely interact with network functions. However, in at least some embodiments, a D-User may be hosted by a 3rd party, e.g., in the cloud.

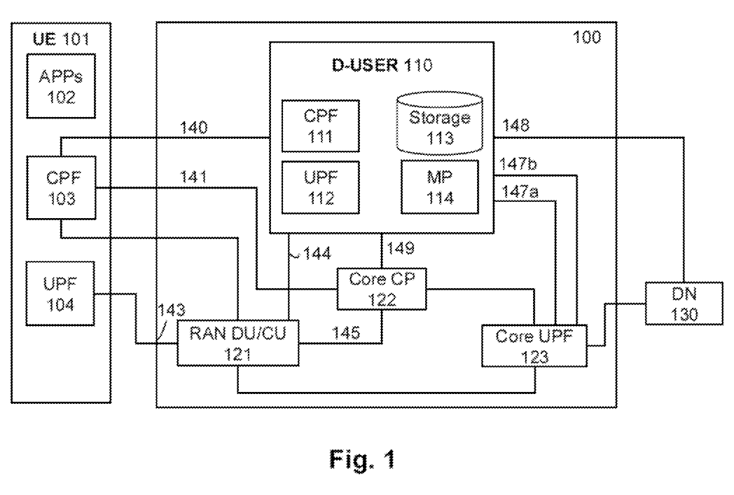

An example set of D-User functions are illustrated in FIG. 1. As seen in FIG. 1, a UE 101 comprises Applications 102, Control Plane Functions (CPF) 103, and User Plane Functions (UPF) 104. CPF 103 may comprise existing control plane functions, as well as new control plane functions for supporting the D-User architecture.

A D-User 110 comprises CPF 111, UPF 112, storage 113, and Management Plane (MP) 114. D-User 110 is deployed by at least one network node. D-User 110 may be deployed at different segments of the network (e.g., Radio Access Network (RAN), Core Network (CN), and Mobile Edge Computing node (MEC), amongst others) in a hierarchical manner to support various UCM services for UEs. D-User 110 may represent UE 101 and facilitate certain actions on behalf of UE 101 to support applications and services engaged throughout the network. There may be different types of D-Users providing different types of UCM services.

D-User 110 and UE 101 communicate with the network 100 through various interfaces. The required interfaces may depend on the type of UCM services, facilitated by D-User 110. A given interface may be used only by some UCM services. In addition to the interfaces that are defined in 5G standards, additional interfaces or additional messaging over the existing interfaces may be required for D-User deployment and operation.

Interface 140 may be used for control plane messaging between UE 101 and D-User 110, and may be transparent to the network. Interface 140 may be used to synchronize UE data (e.g., UE context, location), between UE 101 and D-User 110, to provide authentication, authorization, and information related to the connections between D-User 110 and UE 101, data packet formats and any new UCM protocol data unit (PDU) session initialization. Depending on the UCM service, synchronization of a high volume data flow may require a logical data plane connection between UE 101 and D-User 110.

A data plane connection may be established by the network via interface 143, which may be a Uu interface or a B2 interface, in response to a request from D-User 110 or UE 101. For this purpose, UE 101 may send control plane messages to D-User 110 through interface 140. Network Functions (NF) of network 100 may be configured to interact with UE 101 to obtain a user context.

Interface 144 connects D-User 110 to RAN Distributed Unit/Central Unit 121. Interface 144 may be used for certain UCM services such as, for example, when D-User 110 requires specific radio access network (RAN) technologies or features. D-User 110 may use interface 144 to make such requests. In addition, interface 144 may be used for direct UE functionality authentication, which is similar to an access and mobility-management function (AMF) functionality. For some UCM applications, interface 144 may be used to direct UE traffic to and from the D-User 110, transparent to the hosting network (Core Network or RAN). Interface 144 may be implemented as two interfaces, one for control plane traffic, and one for user plane traffic.

Interface 149 connects D-User 110 with Core Network Control Plane 122. Interface 149 may be used to set up connections, for authentication, authorization and accounting (AAA), for policy update handling and for lifecycle management of network functions at D-User 110.

Interface 147a connects D-User 110 with Core Network UPF 123, and may be used by certain types of UCM services to enable D-User CPF 111 to control CN UPF 123 for routing and data processing purposes. Interface 147a may also be used to monitor UE traffic related information (e.g., resource usage, quality of experience (QoE), different flows routing to different processing functions, UPFs or DNs). NFs in the network (or at least one NF in the network) may be configured to obtain the user traffic/data for internal processing. Interface 147b may be used for certain data processing at D-User 110 or when certain data has to be terminated or started at D-User 110. In this case user traffic originated by UE 101 or the Data Network 130 is diverted to D-User 110 using this interface 147b. NFs in the network (or at least one NF in the network) may be configured to obtain the user traffic/data for internal processing.

Interface 148 connects D-User 110 with Data Network (DN) 130. Interface 148 may be used to send and receive data directly between D-User 110 and DN 130. Interface 148 is required only for certain UCM services.

Interface 141 connects the UE’s CPF 103 with the Access and Mobility Function (AMF) from CN Control Plane 122. In addition to the relevant functions defined in various 3GPP standards, such as for example 3GPP TS 23.501, V18.5.0, or other relevant standards, interface 141 may be used to convey D-User policy and parameters (including D-User service authorization) from the AMF to UE 101, and to convey D-User and UCM interaction capabilities to the AMF. Interface 141 may also be used to establish a sync channel and an initial authentication procedure between D-User 110 and UE 101. The sync channel establishment and authentication may be done by the AMF following a request from a session mobility function (SMF).

Interface 145 connects RAN 121 to CN Control Plane 122 (e.g., the AMF). In addition to the relevant functions defined in 3GPP TS 23.501, interface 145 may be configured to support D-User and UCM services by conveying D-User policies and parameters (including a D-User service authorization) from the AMF to the RAN 121.

An X-centric based 6G architecture may provide Digital World (DW) services through a Network for Digital World (NET4DW). A NET4DW may provide DW services such as a D-User service, digital twin services, and eXtended Reality (X-R) services, amongst others.

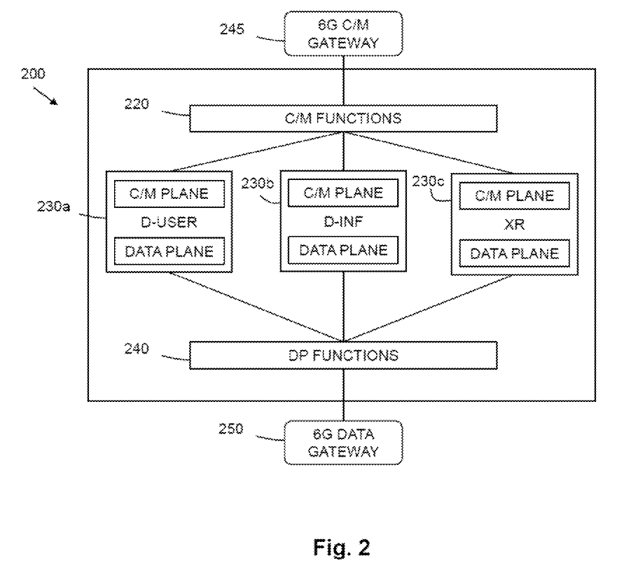

Reference is now made to FIG. 2, in which the architecture of a NET4DW according to at least one embodiment of the present disclosure is illustrated. Specifically, as seen in FIG. 2, a network may comprise a service module 200. Service module 200 comprises D-User platform 230a, D-Inf platform 230b, and X-R service platform 230c. More generally, service module 200 may comprise any number of services platforms and the platforms 230a, 230b, and 230c are provided for illustrative purposes only.

D-User platform 230a may manage D-Users. For example, D-User platform 230a may create, delete, and update D-Users. Similarly, D-Inf platform 230b may manage digital twin services, and X-R platform 230c may manage X-R services. Digital twin services provide digital representations of physical entities.

Each of platforms 230a, 230b, and 230c may communicate with Control and Management (C/M) functions 220 through a C/M plane, as well as with Data Processing (DP) functions 240 through a data plane. C/M functions 220 manage and coordinate platform interactions, and DP functions 240 perform specific processing and operations such as routing.

The NET4DW further comprises C/M functions 220 which may communicate to the network through C/M gateway 245, and DP functions 240 which may communicate to the network through Data gateway 250.

According to at least some embodiments of the present disclosure, a D-User may enable the physical user (P-User) to control a network feature. As a non-limiting example, the network might provide a user with the capability to control several aspects of its traffic such as performing a special processing, taking traffic-related decisions (routing, packet inspection, packet discarding, packet buffering, QoS enforcement, and the like), or controlling a Radio Access Network (RAN) feature. For this purpose, the network may need to expose network-related capabilities and data to the user so that the user may take such decisions.

In other embodiments, the network may decide, based on UCM service type and user requirements (e.g., privacy), to allow a D-User to divert user traffic to the D-User to process the user traffic inside the D-User. To achieve this, the P-user may insert an identifier inside a packet header to identify a type of data processing. Upon receiving the packets, the D-User may, through its internal DPF, identify the data processing type and perform the required analysis. The D-User may then forward the traffic to its specified destination.

In 5G networks, the network allows 3rd parties to influence traffic through the application function (AF). For example, 3^{rd} parties may (1) request traffic steering to an appropriate operator, 3rd party service function, or data network (DN) over N6 interface and (2) request a particular QoS for an AF session, as described in 3GPP, TS 23.501 V17.6.0, Technical Specification Group Services and System Aspects, System architecture for the 5G System (5GS), Sep. 2022, 3GPP, TS 23.502 V18.0.0, Technical Specification Group Services and System Aspects, Procedures for the 5G System (5GS), and 3GPP TS 23.503 V18.2.0, Technical Specification Group Services and System Aspects, Policy and Charging Control Framework for the 5G System (5GS), June 2023, all of which are incorporated herein by reference.

In particular, the AF may request to influence traffic routing decisions and/or request a particular QoS for a particular session by sending to the policy control function (PCF) or network exposure function (NEF) the following information (1) User Equipment (UE) and traffic identifiers such as UE group ID, Data Network Name (DNN), single-network slice selection assistance information (S-NSSAI), application identifier, and traffic filtering info, (2) N6 traffic routing requirements such as a routing profile ID or N6 traffic routing info, (3) spatial and temporal request validity such as when and where the traffic influence should be applied, (4) QoS information such as a QoS reference (in this case, the PCF derives QoS parameters based on service information and the indicated QoS reference) or individual QoS parameters (e.g., requested priority, maximum burst size, requested 5GS delay, requested maximum bitrate, requested guaranteed bitrate and requested packet error rate.

The present disclosure seeks to enable a P-User or UE to have more control of its traffic management inside the network using a D-User. Management of user traffic by the D-User may be achieved by allowing the D-User to control one or more of network features that impact user traffic. Such network features may include without limitation, a RAN feature such as radio channels that can carry user traffic, an antenna technology related feature such as beam selection, MIMO, or a Transport Network (TN) feature. Therefore, unlike current 5G solutions which only allow the AF (but not a user) to influence an AF session or to request a specific QoS for an AF session, embodiments of the present disclosure allow a P-User to control its traffic by exposing one or more of network features to a D-User.

For example, a D-User may choose an appropriate end-to-end path for its traffic depending on, user requirements, path status such as path loading, path cost, and the like. A single end-to-end path might comprise multiple network nodes or functions located at different network domains, such as for example the RAN domain, TN domain, and CN domain. For this, the network may need to expose network-related information from different network domains such as RAN, TN and CN. Such network-related information may include network topology, individual path components information such as enhanced connectivity service (NET4CON) data gateway information, and the like.

According to at least one embodiment, there is provided a method to control user traffic inside the network, including potentially diverting user traffic to a D-User. This method may include a D-User’s policy function (PLF) and the network’s policy function interacting for the purpose of preparing a D-User policy. Unlike in 5G networks, the P-User may, through its D-User, setup policies for controlling different aspects of its traffic. This method may also include deploying one or more of a Network Feature Exposure Function (NFEF) inside different network domains to expose the network’s traffic management capability to a D-User. Furthermore, the method may provide a message flow showing an establishment of a D-User controlled data session under, for example, the framework of an X-centric based 6G architecture.

Embodiments described in the present disclosure may be used in conjunction with, or part of, an operating environment, which is now described.

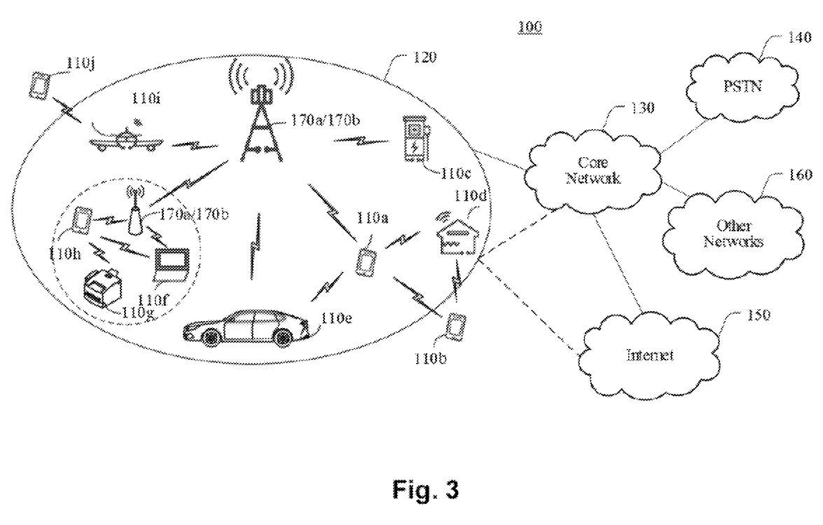

Referring to FIG. 3, as an illustrative and non-limiting example, a simplified schematic illustration of a communication system is provided. The communication system 100 comprises a radio access network 120. The radio access network (RAN) 120 may be a next generation (e.g. 6th generation (6G) or later) radio access network, or a legacy (e.g. 5th generation (5G), 4th generation (4G), 3rd generation (3G) or 2nd generation (2G)) radio access network. In some implementations, 6G radio access refers to the next generation air interface of standards which may comprise both terrestrial networks (TNs) and non-terrestrial networks (NTNs). One or more communication electronic devices (ED) 110a, 110b, 110c, 110d, 110e, 110f, 110g, 110h, 110i, 110j (generically referred to as 110) may be interconnected to one another or connected to one or more network nodes (170a, 170b, generically referred to as 170) in the radio access network 120. A core network 130 may be a part of the communication system and may be dependent or independent of the radio access technology used in the communication system 100. Also, the communication system 100 comprises a public switched telephone network (PSTN) 140, the internet 150, and other networks 160.

In general, the communication system 100 enables multiple wireless or wired elements to communicate data and other content. The communication system 100 may provide content, such as voice, data, video, and/or text, via broadcast, multicast, groupcast, unicast, etc. The communication system 100 may provide a wide range of communication services and applications including enhanced Mobile Broadband (eMBB) services, ultra-reliable low-latency communication (URLLC) services, massive machine type communication (mMTC) services, integrated sensing and communication (ISAC), immersive communication, massive communication, Hyper reliable and low-latency communication, ubiquitous connectivity, integrated AI and communication and other services that can be provided by the future generation communication system. The communication system 100 may provide other services/applications such as earth monitoring, remote sensing, passive sensing and positioning, navigation and tracking, autonomous delivery and mobility, etc.

The communication system 100 may operate by sharing resources, such as carrier spectrum bandwidth, among its constituent elements.

The communication system 100 may include a terrestrial communication system and/or a non-terrestrial communication system. The communication system 100 may provide a high degree of availability and robustness through a joint operation of a terrestrial communication system and a non-terrestrial communication system. For example, integrating a non-terrestrial communication system (or components thereof) into a terrestrial communication system can result in what may be considered a heterogeneous network comprising multiple layers. The heterogeneous network may achieve better overall performance through efficient multi-link joint operation, more flexible functionality sharing, and faster physical layer link switching between terrestrial networks and non- terrestrial networks.

The terrestrial communication system and the non-terrestrial communication system could be considered sub-systems of the communication system.

The electronic device 110 is used to connect persons, objects, machines, etc. The electronic device 110 may be widely used in various scenarios including, for example, cellular communications, device-to-device (D2D), vehicle to everything (V2X), peer-to-peer (P2P), machine-to-machine (M2M), MTC, internet of things (IoT), virtual reality (VR), augmented reality (AR), mixed reality (MR), metaverse, digital twin, industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each electronic device 110 represents any suitable end user device for wireless operation and may include such devices (or may be referred to but not limited to) as a user equipment (UE) or a user device or a terminal, a wireless transmit/receive unit (WTRU), a mobile station, a fixed or mobile subscriber unit, a cellular telephone, a station (STA), a MTC device, a personal digital assistant (PDA), a smartphone, a laptop, a computer, a tablet, a wireless sensor, a consumer electronics device, a smart book, a vehicle, a car, a truck, a bus, a train, or an IoT device, wearable devices (such as a watch, a pair of glasses, head mounted equipment, etc.), an industrial device, or an apparatus in (e.g. communication module, modem, or chip) or comprising the foregoing devices, among other possibilities. Future generation electronic devices 110 may be referred to using other terms.

Network node 170 may be a base station. A base station is a network element in radio access network responsible for radio transmission and reception in one or more cells to or from the user equipment. The base stations 170a-170b may be known by other names in some implementations, such as a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), a wireless router, a relay station, a terrestrial node, a terrestrial network device, a terrestrial base station, a positioning node, among other possibilities. The base stations 170a-170b may be a macro base station (BS), a pico BS, a relay node, a donor node, or the like, or combinations thereof.

Network elements, as the term is used herein, may refer to any network node that may receive communications from user equipment, either directly or indirectly. For example, a network element may be a device as illustrated in FIGS. 2 to 5 and 13.

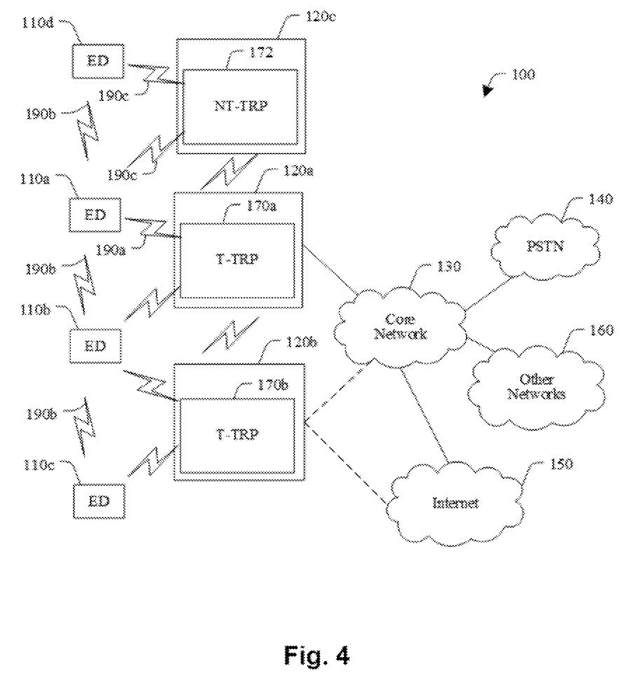

Reference is now made to FIG. 4, which illustrates an example communication system 100. In general, the communication system 100 enables multiple wireless or wired elements to communicate data and other content. The purpose of the communication system 100 may be to provide content, such as voice, data, video, and/or text, via broadcast, multicast, groupcast, unicast, and the like. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, and the like). The communication system 100 may provide a high degree of availability and robustness through a joint operation of a terrestrial communication system and a non-terrestrial communication system. For example, integrating a non-terrestrial communication system (or components thereof) into a terrestrial communication system can result in what may be considered a heterogeneous network comprising multiple layers. Compared to conventional communication networks, the heterogeneous network may achieve better overall performance through efficient multi-link joint operation, more flexible functionality sharing, and faster physical layer link switching between terrestrial networks and non- terrestrial networks.

The terrestrial communication system and the non-terrestrial communication system could be considered sub-systems of the communication system. In the example shown in FIG. 4, the communication system 100 includes electronic devices (ED) 110a, 110b, 110c, 110d (generically referred to as ED 110), radio access networks (RANs) 120a, 120b, a non-terrestrial communication network 120c, a core network 130, a public switched telephone network (PSTN) 140, the Internet 150, and other networks 160. The RANs 120a, 120b include respective base stations (BSs) 170a, 170b, which may be generically referred to as terrestrial transmit and receive points (T-TRPs) 170a, 170b. The non-terrestrial communication network 120c includes an access node 172, which may be generically referred to as a non-terrestrial transmit and receive point (NT-TRP) 172.

Any ED 110 may be alternatively or additionally configured to interface, access, or communicate with any T-TRP 170a,170b and NT-TRP 172, the Internet 150, the core network 130, the PSTN 140, the other networks 160, or any combination of the preceding. In some examples, ED 110a may communicate an uplink and/or downlink transmission over a terrestrial air interface 190a with T-TRP 170a. In some examples, the EDs 110a, 110b, 110c, and 110d may also communicate directly with one another via one or more sidelink air interfaces 190b. In some examples, ED 110d may communicate an uplink and/or downlink transmission over a non-terrestrial air interface 190c with NT-TRP 172.

The air interfaces 190a and 190b may use similar communication technology, such as any suitable radio access technology. For example, the communication system 100 may implement one or more channel access methods, such as code division multiple access (CDMA), space division multiple access (SDMA), time division multiple access (TDMA), frequency division multiple access (FDMA), orthogonal FDMA (OFDMA), or single-carrier FDMA (SC-FDMA, also known as discrete Fourier transform spread OFDMA, DFT-s-OFDMA) in the air interfaces 190a and 190b. The air interfaces 190a and 190b may utilize other higher dimension signal spaces, which may involve a combination of orthogonal and/or non-orthogonal dimension.

The non-terrestrial air interface 190c can enable communication between the ED 110d and one or multiple NT-TRPs 172 via a wireless link or simply a link. For some examples, the link is a dedicated connection for unicast transmission, a connection for broadcast transmission, or a connection between a group of EDs 110 and one or multiple NT-TRPs 172 for multicast transmission.

The RANs 120a and 120b are in communication with the core network 130 to provide the EDs 110a, 110b, and 110c with various services such as voice, data, and other services. The RANs 120a and 120b and/or the core network 130 may be in direct or indirect communication with one or more other RANs (not shown), which may or may not be directly served by core network 130, and may or may not employ the same radio access technology as RAN 120a, RAN 120b or both. The core network 130 may also serve as a gateway access between (i) the RANs 120a and 120b or EDs 110a, 110b, and 110c or both, and (ii) other networks (such as the PSTN 140, the Internet 150, and the other networks 160). In addition, some or all of the EDs 110a, 110b, and 110c may include functionality for communicating with different wireless networks over different wireless links using different wireless technologies and/or protocols. Instead of wireless communication (or in addition thereto), the EDs 110a, 110b, and 110c may communicate via wired communication channels to a service provider or switch (not shown), and to the Internet 150. PSTN 140 may include circuit switched telephone networks for providing plain old telephone service (POTS). Internet 150 may include a network of computers and subnets (intranets) or both, and incorporate protocols, such as Internet Protocol (IP), Transmission Control Protocol (TCP), User Datagram Protocol (UDP). EDs 110a, 110b, and 110c may be multimode devices capable of operation according to multiple radio access technologies, and incorporate multiple transceivers necessary to support such.

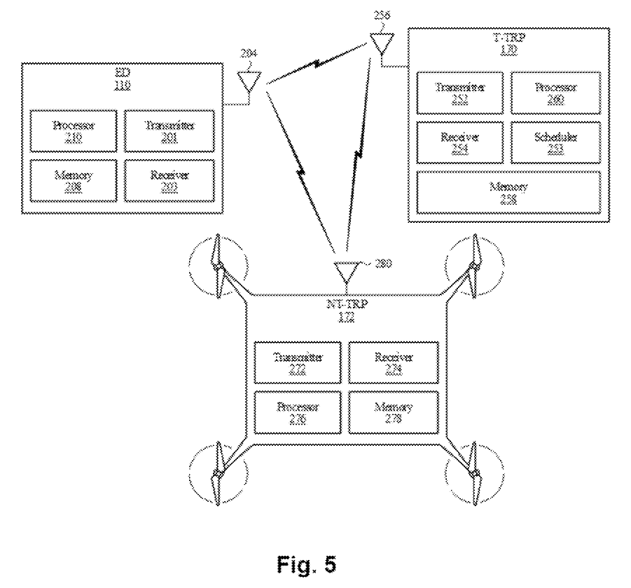

FIG. 5 illustrates another example of an ED 110 and a base station 170a, 170b and/or 170c. The ED 110 is used to connect persons, objects, and machines, amongst others. The ED 110 may be widely used in various scenarios including, for example, cellular communications, device-to-device (D2D), vehicle to everything (V2X), peer-to-peer (P2P), machine-to-machine (M2M), machine-type communications (MTC), internet of things (IoT), virtual reality (VR), augmented reality (AR), mixed reality (MR), metaverse, digital twin, industrial control, self-driving, remote medical, smart grid, smart furniture, smart office, smart wearable, smart transportation, smart city, drones, robots, remote sensing, passive sensing, positioning, navigation and tracking, autonomous delivery and mobility, amongst others.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, wearable devices (such as a watch, a pair of glasses, head mounted equipment, and the like), an industrial device, or an apparatus in (e.g. communication module, modem, or chip) or comprising the foregoing devices, among other possibilities. Future generation EDs 110 may be referred to using other terms. The base station 170a and 170b is a T-TRP and will hereafter be referred to as T-TRP 170. Also shown in FIG. 5, a NT-TRP will hereafter be referred to as NT-TRP 172. Each ED 110 connected to T-TRP 170 and/or NT-TRP 172 can be dynamically or semi-statically turned-on (i.e., established, activated, or enabled), turned-off (i.e., released, deactivated, or disabled) and/or configured in response to one of more of: connection availability and connection necessity.

The ED 110 includes a transmitter 201 and a receiver 203 coupled to one or more antennas 204. Only one antenna 204 is illustrated to avoid congestion in the drawing. One, some, or all of the antennas 204 may alternatively be panels. The transmitter 201 and the receiver 203 may be integrated, e.g. as a transceiver. The transceiver is configured to modulate data or other content for transmission by at least one antenna 204 or Network Interface Controller (NIC). The transceiver is also configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by one or more processing unit(s) (e.g., a processor 210). Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache, and the like.

The ED 110 may further include one or more input/output devices (not shown) or interfaces (such as a wired interface to the Internet 150 in FIG. 4). The input/output devices or interfaces permit interaction with a user or other devices in the network. Each input/output device or interface includes any suitable structure for providing information to or receiving information from a user, and/or for network interface communications. Suitable structures include, for example, a speaker, microphone, keypad, keyboard, display, touch screen, and the like.

The ED 110 includes the processor 210 for performing operations including those operations related to preparing a transmission for uplink transmission to the NT-TRP 172 and/or the T-TRP 170; those operations related to processing downlink transmissions received from the NT-TRP 172 and/or the T-TRP 170; and those operations related to processing sidelink transmission to and from another ED 110. Processing operations related to preparing a transmission for uplink transmission may include operations such as encoding, modulating, transmit beamforming, and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g. by detecting and/or decoding the signaling). An example of signaling may be a reference signal transmitted by the NT-TRP 172 and/or by the T-TRP 170. In some embodiments, the processor 210 implements the transmit beamforming and/or the receive beamforming based on the indication of beam direction, e.g. beam angle information (BAI), received from the T-TRP 170. In some embodiments, the processor 210 may perform operations relating to network access (e.g. initial access) and/or downlink synchronization, such as operations relating to detecting a synchronization sequence, decoding and obtaining the system information, and the like. In some embodiments, the processor 210 may perform channel estimation, e.g. using a reference signal received from the NT-TRP 172 and/or from the T-TRP 170.

Although not illustrated, the processor 210 may form part of the transmitter 201 and/or part of the receiver 203. Although not illustrated, the memory 208 may form part of the processor 210.

The processor 210, the processing components of the transmitter 201, and the processing components of the receiver 203 may each be implemented by the same or different one or more processors that are configured to execute instructions stored in a memory (e.g. in the memory 208). Alternatively, some or all of the processor 210, the processing components of the transmitter 201, and the processing components of the receiver 203 may each be implemented using dedicated circuitry, such as a programmed field-programmable gate array (FPGA), an application-specific integrated circuit (ASIC), or a hardware accelerator such as a graphics processing unit (GPU) or an artificial intelligence (AI) accelerator.

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), a wireless router, a relay station, a terrestrial node, a terrestrial network device, a terrestrial base station, a base band unit (BBU), a remote radio unit (RRU), an active antenna unit (AAU), a remote radio head (RRH), a central unit (CU), a distributed unit (DU), a positioning node, among other possibilities. The T-TRP 170 may be a macro BS, a pico BS, a relay node, a donor node, or the like, or combinations thereof. The T-TRP 170 may refer to the foregoing devices or refer to apparatus (e.g. a communication module, a modem, or a chip) in the foregoing devices.

In some embodiments, the parts of the T-TRP 170 may be distributed. For example, some of the modules of the T-TRP 170 may be located remote from the equipment that houses the antennas 256 for the T-TRP 170, and may be coupled to the equipment that houses the antennas 256 over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment that houses the antennas 256 of the T-TRP 170. The modules may also be coupled to other T-TRPs. In some embodiments, the T-TRP 170 may actually be a plurality of T-TRPs that are operating together to serve the ED 110, e.g. through the use of coordinated multipoint transmissions.

The T-TRP 170 includes at least one transmitter 252 and at least one receiver 254 coupled to one or more antennas 256. Only one antenna 256 is illustrated to avoid congestion in the drawing. One, some, or all of the antennas 256 may alternatively be panels. The transmitter 252 and the receiver 254 may be integrated as a transceiver. The T-TRP 170 further includes a processor 260 for performing operations including those related to: preparing a transmission for downlink transmission to the ED 110, processing an uplink transmission received from the ED 110, preparing a transmission for backhaul transmission to the NT-TRP 172, and processing a transmission received over backhaul from the NT-TRP 172. Processing operations related to preparing a transmission for downlink or backhaul transmission may include operations such as encoding, modulating, precoding (e.g. multiple input multiple output (MIMO) precoding), transmit beamforming, and generating symbols for transmission. Processing operations related to processing received transmissions in the uplink or over backhaul may include operations such as receive beamforming, demodulating received symbols, and decoding received symbols. The processor 260 may also perform operations relating to network access (e.g. initial access) and/or downlink synchronization, such as generating the content of synchronization signal blocks (SSBs), generating the system information, and the like. In some embodiments, the processor 260 also generates an indication of beam direction, e.g. BAI, which may be scheduled for transmission by a scheduler 253. The processor 260 performs other network-side processing operations described herein, such as determining the location of the ED 110, determining where to deploy the NT-TRP 172, and the like. In some embodiments, the processor 260 may generate signaling, e.g. to configure one or more parameters of the ED 110 and/or one or more parameters of the NT-TRP 172. Any signaling generated by the processor 260 is sent by the transmitter 252. Note that “signaling”, as used herein, may alternatively be called control signaling. Signaling may be transmitted in a physical layer control channel, e.g. a physical downlink control channel (PDCCH), in which case the signaling may be known as dynamic signaling. Signaling transmitted in a downlink physical layer control channel may be known as Downlink Control Information (DCI). Signaling transmitted in an uplink physical layer control channel may be known as Uplink Control Information (UCI). Signaling transmitted in a sidelink physical layer control channel may be known as Sidelink Control Information (SCI). Signaling may be included in a higher-layer (e.g., higher than physical layer) packet transmitted in a physical layer data channel, e.g. in a physical downlink shared channel (PDSCH), in which case the signaling may be known as higher-layer signaling, static signaling, or semi-static signaling. Higher-layer signaling may also refer to Radio Resource Control (RRC) protocol signaling or Media Access Control – Control Element (MAC-CE) signaling.

The scheduler 253 may be coupled to the processor 260. The scheduler 253 may be included within or operated separately from the T-TRP 170. The scheduler 253 may schedule uplink, downlink, sidelink, and/or backhaul transmissions, including issuing scheduling grants and/or configuring scheduling-free (e.g., “configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or part of the receiver 254. Also, although not illustrated, the processor 260 may implement the scheduler 253. Although not illustrated, the memory 258 may form part of the processor 260.

The processor 260, the scheduler 253, the processing components of the transmitter 252, and the processing components of the receiver 254 may each be implemented by the same or different one or more processors that are configured to execute instructions stored in a memory, e.g. in the memory 258. Alternatively, some or all of the processor 260, the scheduler 253, the processing components of the transmitter 252, and the processing components of the receiver 254 may be implemented using dedicated circuitry, such as a programmed FPGA, a hardware accelerator (e.g., a GPU or AI accelerator), or an ASIC.

Although the NT-TRP 172 is illustrated as a drone only as an example, the NT-TRP 172 may be implemented in any suitable non-terrestrial form, such as satellites and high altitude platforms, including international mobile telecommunication base stations and unmanned aerial vehicles, for example. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated to avoid congestion in the drawing. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110, processing an uplink transmission received from the ED 110, preparing a transmission for backhaul transmission to T-TRP 170, and processing a transmission received over backhaul from the T-TRP 170. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, demodulating received symbols, and decoding received symbols. In some embodiments, the processor 276 implements the transmit beamforming and/or receive beamforming based on beam direction information (e.g. BAI) received from the T-TRP 170. In some embodiments, the processor 276 may generate signaling, e.g. to configure one or more parameters of the ED 110. In some embodiments, the NT-TRP 172 implements physical layer processing, but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or part of the receiver 274. Although not illustrated, the memory 278 may form part of the processor 276.

The processor 276, the processing components of the transmitter 272, and the processing components of the receiver 274 may each be implemented by the same or different one or more processors that are configured to execute instructions stored in a memory, e.g. in the memory 278. Alternatively, some or all of the processor 276, the processing components of the transmitter 272, and the processing components of the receiver 274 may be implemented using dedicated circuitry, such as a programmed FPGA, a hardware accelerator (e.g., a GPU or AI accelerator), or an ASIC. In some embodiments, the NT-TRP 172 may actually be a plurality of NT-TRPs that are operating together to serve the ED 110, e.g. through coordinated multipoint transmissions.

The T-TRP 170, the NT-TRP 172, and/or the ED 110 may include other components, but these have been omitted for the sake of clarity.

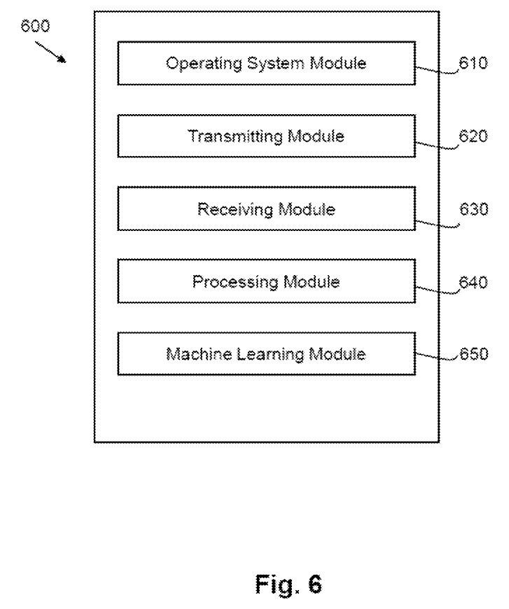

One or more steps of the embodiment methods provided herein may be performed by corresponding units or modules, according to FIG. 6. FIG. 6 illustrates units or modules in a device 600, such as in the ED 110, in the T-TRP 170, or in the NT-TRP 172. For example, the device may comprise an Operating System module 610. A signal may be transmitted by a transmitting unit or by a transmitting module 620. A signal may be received by a receiving unit or by a receiving module 630. A signal may be processed by a processing unit or a processing module 640. Other steps may be performed by an artificial intelligence (AI) or machine learning (ML) module 650. The respective units or modules may be implemented using hardware, one or more components or devices that execute software, or a combination thereof. For instance, one or more of the units or modules may be a circuit such as an integrated circuit. Examples of an integrated circuit includes a programmed FPGA, a GPU, or an ASIC. For instance, one or more of the units or modules may be logical such as a logical function performed by a circuit, by a portion of an integrated circuit, or by software instructions executed by a processor. It will be appreciated that where the modules are implemented using software for execution by a processor for example, the modules may be retrieved by a processor, in whole or part as needed, individually or together for processing, in single or multiple instances, and that the modules themselves may include instructions for further deployment and instantiation.

Additional details regarding the EDs 110, the T-TRP 170, and the NT-TRP 172 are known to those of skill in the art. As such, these details are omitted here.

The solution described in the application is applicable to a next generation (e.g. sixth generation (6G) or later) network, or a legacy (e.g. 5G, 4G, 3G or 2G) network.

The proposed 6G System architecture is defined to support 6G XaaS services by using techniques such as Network Function Virtualization and Network Slicing. The 6G System architecture utilizes service-based interactions between 6G services.

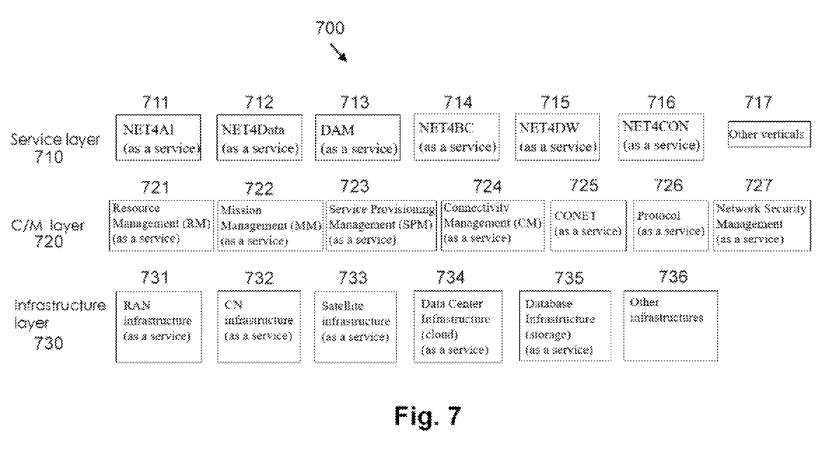

The 6G System leverages service-based architecture and XaaS concept. XaaS services in the 6G System are categorized into three layers. A 6G System conceptual structure 700 is shown in FIG. 7.

Infrastructure Layer 730 includes infrastructures supporting 6G services. Among them are wireless networks (RAN, CN) infrastructures 731 and 732, Cloud/data center infrastructures 734, satellite infrastructure 733, and storage/database infrastructures 735. Infrastructure Layer 730 may further include other infrastructures 736 including for example, sensing networks, and the like. These infrastructures can be provided by a single provider or by multiple providers.

Each of the infrastructures could have its control and management functions, denoted as C/M functions, for infrastructure management. Each of these infrastructures is one type of Infrastructure as a Service.

Control and Management (C/M) layer 720 includes control and management services of the 6G System. They are developed and deployed by using slicing techniques and utilizing resource provided by infrastructure layer. 6G services in Control and Management (C/M) layer are:

Resource Management (RM) as a Service 721 provides a capability of life-cycle management of a variety of slices and over-the-air resource assignment to wireless devices.

Mission Management (MM) as a Service 722 provides a capability to program provisioning of XaaS services at a Service Layer to provide mission services. A 6G mission is defined as a service provided to customers by the 6G System. A mission can be a type of services which is provided by a single 6G XaaS service or a type of services that needs contributions from multiple XaaS services.

Confederation Network (CONET) as a Service 725 provides a capability to enable multiple partners to jointly provide 6G services. This capability is provided by confederation formation, mutual authentication, mutual authorization among partners and negotiation of an agreement on recording and retracing selected actions performed by partners, in order to assure a trustworthy environment within 6G System operations.

Service Provisioning Management (SPM) 723 as a Service provides a capability of control and management of 6G service access by customers and provisioning of requested services. The capability is provided by unified mutual authentication, authorization and policy, key management, QoS assurance and charging between any pair of XaaS service provider and customer. The customers include end-customers not only in physical world, but also digital representatives in digital world.

Connectivity Management (CM) as a Service 724 leverages 5G connectivity management functions, but with an extension to include digital world.

Protocol as a Service 726 provides a capability to design service customized protocol stacks for identified interfaces. The protocol stacks could be pre-defined for on-demand selection, or could be designed on-demand.

Network Security 727 as a Service provides a capability for owners of infrastructures to detect potential security risks of their infrastructures.

XaaS services in C/M Layer 720 support control and management of the 6G System itself and also provide support to verticals if requested. For example, the RM service 721 may serve a RAN for over-the-air resource management and may also provide service to a vertical for the vertical’s over-the-air resource allocation to its end-customers. The XaaS in C/M layer may be deployed by using slicing techniques.

Service Layer 710 includes 6G services which provide services to customers. Service Layer 710 may include:

An AI service 711 denoted as NET4AI as a Service. Artificial Intelligence service 711 provides AI capability to support a variety of AI applications.

A service of data collection, data sanitization, data analysis and data delivery is denoted as DAM as a Service 713. This service provides lifecycle management of statistic data, including acquisition, de-privatization, analysis and delivery of data which from any type of sensor, device, network function, and the like.

A service of data storage and data sharing is denoted as NET4Data as a Service 712. This service provides trustworthy storage and sharing of data for data owners, while following recognized authorities’ regulations on control of identified data.

A Digital World service, denoted as NET4DW as a Service 715, provides a capability to construct, control and manage a digital realization of the physical world.

A block chain service is denoted as NET4BC as a Service 714. NET4Con as a Service 716 provides support to 6G block chain services.

Enhanced connectivity service, e.g., network for connectivity (NET4CON) as a Service 716 supports the exchange of messages and data among new 6G services.

XaaS services of the Service Layer 710 are developed and deployed by using resources provided by Infrastructure Layer 730 and by utilizing Network Function Virtualization and Slicing techniques. The capability of each 6G service is provided by its control and management functions and service specific data process functions.

In addition to supporting 6G XaaS services from Service Layer 710, the 6G System leverages the 5G System for provisioning of vertical services. The difference between 6G XaaS services and other verticals is that a vertical is a pure customer which needs other XaaS services to enable its operation, while each XaaS service provides its capabilities to 6G customers.

Any pair of XaaS services of the 6G System could also be mutual customers and providers of each other. For example, an infrastructure owner may provide its resource to XaaS services in Service Layer 710 and C/M Layer 720, and RM service 721 may need the capabilities provided by NET4AI 711, DAM 713, and NET4DW 715 in order to utilize vertical slicing in the provision of resource management services. Similarly, CONET service 725 and NET4Data service 712 may need the capability provided by NET4BC for their operation.

### The key concepts of a 6G System include:

Defining basic XaaS Services by decoupling comprehensive types of services into basic XaaS services. A basic XaaS service provides a unique capability to enable a specific type of service, such as a NET4AI service, a NET4DW service, a DAM service, a NET4Data service, a Block chain service, a mission management service, amongst others.

Allowing the joint operation of the 6G System by multiple partners.

Defining a Data Plane of the 6G System including processing functions of data planes for XaaS services. Programing the interconnection of these functions, by the mission management service, enables a variety of customized customer services.

Simplifying the 6G System architecture by categorizing basic control services and management services and combining them as basic XaaS services in the Control and Management (C/M) Layer.

Defining the C/M Layer of the 6G System including C/M functions as XaaS services and optionally including 5G Control Plane (CP), such as Access and Mobility Functions (AMF).

Defining a Basic Architecture Structure (BAS) which is a unified basic structure with minimized number of interfaces and is independent from types of infrastructures.

Simplifying standardization, development and deployment of the 6G System using the BAS concept, while supporting a variety of infrastructure deployment scenarios.

Adapting to a variety of deployment scenarios by applying the BAS or a subset of it to infrastructures based on capability, capacity and requirement of the infrastructure networks.

Leveraging the Service Based Interface (SBI) interface concept and applying SBI interaction in both 6G C/M plane and 6G data plane.

Simplifying the SBI interfaces by introducing trustworthy gateways in both the C/M plane and the data plane.

Improving trustworthiness from the perspective of operators of the 6G System by introducing CONET capability, NET4BC capability and anonymous service provisioning provided by trustworthy gateways in the C/M plane and data plane of the 6G System.

Improving trustworthiness for end customer privacy protection by unified mutual authentication, Identity Management (IDM), data sanitization and the like, as provided by the SPM service, the DAM service and the 6G Block Chain service.

Simplifying roaming management for wireless devices, in the physical world and the digital world, by unifying authentication across all participating partners and customers.

Supporting multiple development paths from the 5G System to the 6G System by defining multiple architecture options without incurring much efforts due to the introduction of the BAS concept.

Supporting backward compatibility by utilizing the benefits of a Service Based Architecture (SBA) and its add-on features, allowing 5G users to use the 6G System to access 5G services.

Supporting future extensions by adding new XaaS services with minimal impact on standardization and deployment, due to the anonymous service provisioning concept implemented by trustworthy gateways in the 6G C/M plane and in the 6G data plane.

### Controlling Network Traffic with a D-User

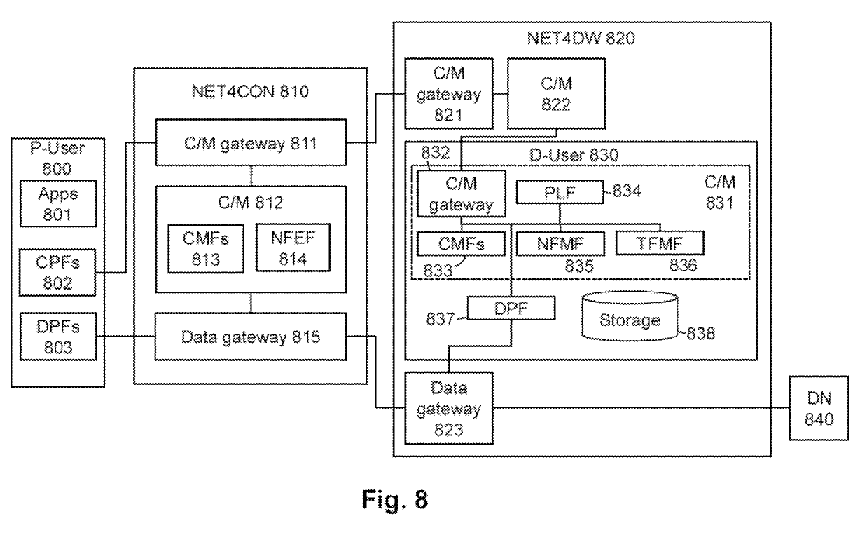

Reference is now made to FIG. 8, in which a P-User and a D-User interfacing with an enhanced connectivity service (e.g., NET4CON) is illustrated.

As seen in FIG. 8, P-User 800 comprises apps 801, control plane functions 802, and data plane functions 803.

An enhanced connectivity service such as NET4CON 810 comprises a Control and Management (C/M) gateway 811, data gateway 815, and C/M plane 812. C/M plane 812 comprises a Network Feature Exposure Function (NFEF) 814 and other C/M functions 813. Although in this example, NET4CON 810 has a single C/M gateway 811, a single data gateway 815, a single C/M 812, and a single NFEF 814, this is for illustrative purposes only. In other embodiments, NET4CON 810 may include multiple C/M gateways 811, multiple data gateways 815, multiple C/M 812, and multiple NFEFs 814 deployed in network domains such as a RAN domain, a CN domain and a TN domain. Moreover, while FIG. 8 illustrates a D-User controlling data gateway 815, the D-User may also control multiple data gateways, one or more DPFs, and one or more RAN features based on the techniques of the present disclosure.

A D-User 830 may be hosted by a service such as NET4DW 820. NET4DW 820 may comprise C/M gateway 821, C/M plane 822, and Data gateway 823.

D-User 830 comprises a C/M plane 831 comprising C/M gateway 832, Policy Function (PLF) 834, Network Feature Management Function (NFMF) 835, Traffic Management Function (TFMF) 836, and other Control and Management Functions (CMF) 833. CMF 833 may comprise any other C/M function other than PLF 834, NFMF 835, TFMF 836.

D-User C/M functions such as C/M functions 833, PLF 834, NFMF 835, and TFMF 836 may interact with NET4CON C/M 812 through D-User C/M gateway 832 and NET4CON C/M gateway 811. For example, NFMF 835 may send a message to NFEF 814 by first sending the message to the D-User C/M gateway 832 which then forwards the message to the NET4CON C/M gateway 811. The message may then be sent by NET4CON C/M gateway 811 to NFEF 814.

In at least some embodiments, the message may be forwarded in a hierarchical manner. For example, D-User NFMF 835 may communicate externally by sending a message to the D-User C/M gateway 832 which then forwards the message to C/M gateway 821 of the platform hosting the D-User (e.g., NET4DW or D-User platform). The hosting platform C/M gateway 821 may then forward the message to NET4CON C/M gateway 811 which then forwards the message to NFEF 814.

### Network Feature Exposure Function

According to at least some embodiments of the present disclosure, there is provided one or more Network Feature Exposure Function (NFEF) to be deployed inside the network. Each NFEF may expose a network’s features to a D-User and enables the D-User to operate and control the network’s feature. Several network features may be exposed to a D-User, including without limitation, network functionality (e.g., data processing, traffic management, etc.), technology (e.g., controlling low power channels at RAN, applying Multiple-Input Multiple-Output (MIMO) technology), and resources.

Depending on the network feature to expose, an NFEF may have several tasks. To expose a traffic management capability to a D-User, the NFEF may have the following tasks.

Exposure of the network’s feature-related data: An NFEF may provide a D-User with traffic related data so that the D-User may prepare a policy. For example, the NFEF may expose data gateways and/or DPF loading, QoS information per data gateway or DPF, path cost, resource usage, radio channel quality, interference, and the like. Which network segment and what kind of data to expose to a D-User may be determined by the network. However, in at least some embodiments D-User input may also be considered by the network when making that determination, for example, when the D-User has previously operated the network feature.

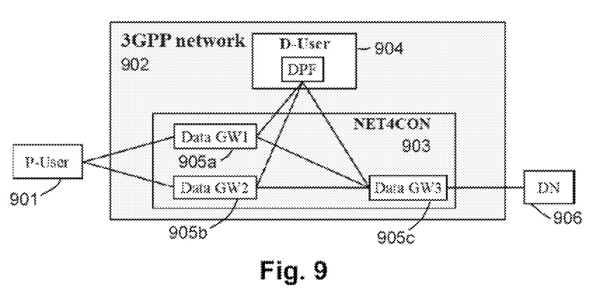

Level of exposed feature-related details: Each network feature may provide its own level of control. For example, when exposing path selection capability to a D-User, the network may allow a D-User to route traffic between two network nodes, and also to choose how traffic is routed between the two network nodes, thereby providing more control and capability to the D-User. As illustrated in FIG. 9, a network 902 may comprise multiple paths between P-User 901 and a Data Network (DN) 906 passing through a D-User 904 and data gateways 905a, 905b, and 905c of NET4CON service 903. Thus, network 902 may allow D-User 904 to route P-User traffic to a given data network, such as DN 906, but may also allow D-User 904 to choose how traffic reaches DN 906 internally. Specifically, D-User 904 may select data gateway 905a or data gateway 905b for P-User traffic to reach D-User 904 and DN 906. In at least some embodiments of the present disclosure an NFEF may provide the following exposure levels:

Detailed path descriptions comprising individual path components (e.g., DPF(s) and data gateways) and their loadings, QoS information and processing cost of each individual path component.

Abstract path descriptions comprising end-to-end path capability such as aggregate path processing cost (summation of processing costs of individual path components), aggregate processing capability, and the like.

Abstract virtual network topology. In this case, the network does not expose its internal path details but maps its path details to a virtual network to allow a D-User to select a path of the virtual network. A path selected by the D-User based on the virtual network is then mapped to the real network.

Feature-related parameters translation: Each feature may have its own control and management parameters. A network may keep some control information hidden from a D-User (e.g., as in 5G networks, a network may not allow the AF to setup a User Plane Function). Furthermore, it may be beyond the D-User’s capability to directly control some feature-related parameters. Therefore, in at least some embodiments, the network (in particular, the NFEF) derives feature-related parameters from D-User PLF parameters. In at least some other embodiments, the network may provide a feature template to the D-User to prepare a policy.

### Direct and Indirect Traffic Management

According to at least some embodiments, the present disclosure provides for controlling traffic management features by a D-User. This may be achieved by the D-User indirectly configuring one or more DPFs and/or one or more data gateways according to a D-User policy. Alternatively, the D-User may directly configure DPFs and/or data gateways.

In indirect feature management, the D-User controls the network feature through the network entity responsible for managing the network feature. The D-User may prepare its policy considering the pre-policy rules determined by the network, and then instruct the network entity controlling the feature to implement the policy. For example, the D-User may instruct a NET4CON C/M plane to configure the NET4CON data gateway according to the policy. Indirect network feature management is better suited for network features which the D-User shares with others.

In direct feature management, the D-User controls the network feature directly by configuring the network entity responsible for the network feature. For example, a D-User having the capability to manage its traffic routing inside the network may configure the NET4CON data gateway directly according to its policy set by the D-User PLF. Direct feature management is better suited for network features which are dedicated to the D-User and not shared with others.

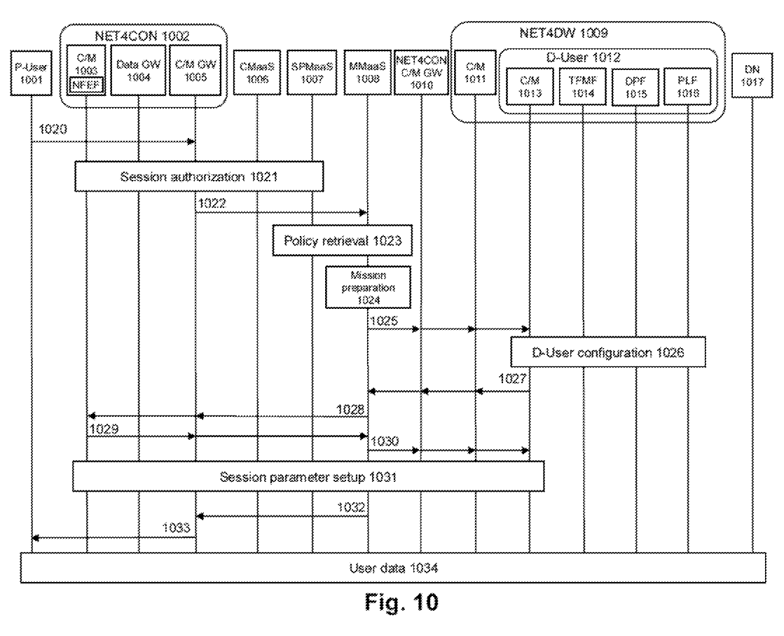

Reference is now made to FIG. 10 in which a method for establishing a D-User controlled data session according to at least one embodiment of the present disclosure is illustrated.

In the embodiment of FIG. 10, P-User 1001 may have established a 6G C/M connection with its serving C/M gateway 1005. A corresponding UCM service may have been authorized and the UCM service’s supporting functions, such as the NFEF of C/M plane 1003 inside NET4CON 1002 have been created. D-User 1011’s capability may have been exposed to Mission Manager as a Service (MMaS) 1008.

The method illustrated in FIG. 10 establishes a new session between P-User 1001 and a Data Network (DN) 1017 with the capability for P-User 1001 to manage its own traffic by (1) having internal data processing functions (DPFs 1015) inside D-User 1011, and (2) exposing the network’s traffic-related management capability to D-User 1011.

As seen in FIG. 10, the method starts by P-User 1001 sending a session establishment request 1020 to a serving C/M gateway, such as C/M gateway 1005 from NET4CON service 1002. NET4CON service 1002 may be implemented, in at least some embodiments, in the Radio Access Network (RAN). Request 1020 may include, without limitation, a use case ID (i.e., the requested traffic management capability), D-User ID, session type, QoS info, and Data Network ID, amongst others.

Upon receiving request 1020, NET4CON C/M gateway 1005 triggers a UCM session authorization 1021 by interacting with SPMaaS 1007 to determine user subscription information stored in SPMaaS 1007. This step may also include a data radio bearer setup. In some embodiments, the NET4CON C/M gateway 1005 may pass message 1020 to other NET4CON C/M functions 1003 which in turn triggers UCM session authorization 1021 by interacting with SPMaaS 1007 to determine user subscription information stored in SPMaaS 1007.

Once user subscription information is confirmed, NET4CON C/M gateway 1005 may send a request 1022 to MMaS 1008 to establish a UCM session between P-User 1001 and DN 1017 through network data gateways and D-User 1011’s DPFs. Request 1022 may include, without limitation, serving data gateway IDs, P-User ID, D-User ID, use case type (i.e., traffic management), and session-related information such as QoS information, and session type, amongst others.

MMaS 1008 may then communicate with SPMaaS 1007 to retrieve the UCM session policy as indicated by block 1023. The session policy may include, without limitation, traffic management related policy rules (e.g., packet forwarding, packet inspection, QoS handling, and the like), reporting related rules (traffic volume, loading, and the like), and billing-related rules.

MMaS 1008 may then prepare the mission information based on the information retrieved from the SPMaaS 1007 and the UCM session requirements, as illustrated by block 1024.

MMaS 1008 may then send a request 1025 to D-User 1012 through NET4CON C/M plane gateway 1010 and NET4DW 1009’s C/M plane 1011 to configure D-User’s 1011 supporting functions. Request 1025 may include, without limitation, a D-User ID, the session policy retrieved from SPMaaS 1007, UCM session ID, and QoS requirements. D-User 1012’s internal function configuration may be done by D-User 1012 according to D-User 1012’s internal policies, as set by the D-User PLF 1016, and according to the policy rules retrieved from SPMaaS 1007.

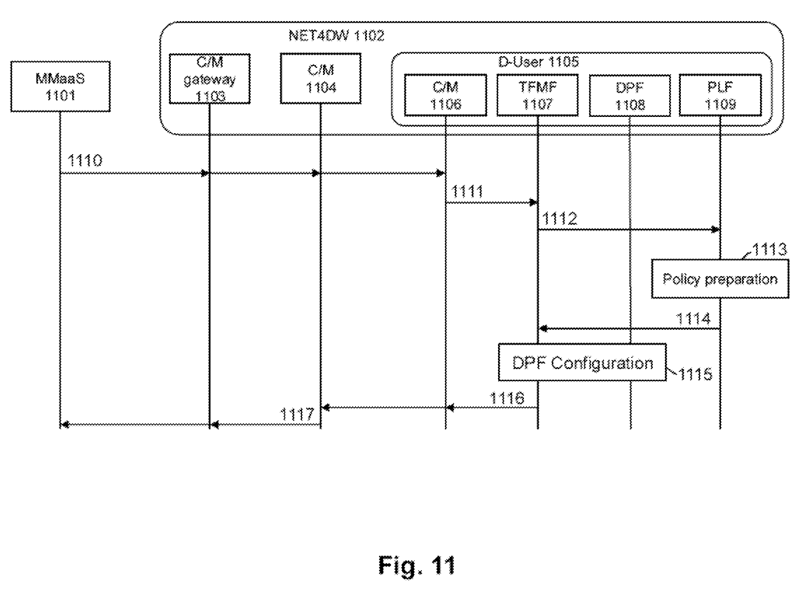

Upon receiving request 1025, D-User C/M plane 1013 may prepare session policy rules and configure D-User functions accordingly, as illustrated by block 1026. D-User C/M plane 1013 may configure its functions considering several policy sources, such as for example, policies set by D-User PLF 1016 and policies received from SPMaaS 1007. D-User configuration is described in greater detail with respect to FIG. 11, below.

Upon D-User configuration being complete, D-User C/M plane 1013 may then acknowledge the completion of the D-User configuration with message 1027 to MMaaS 1008.

MMaaS 1008 may then send a request 1028 to NET4CON C/M 1003 through NET4CON C/M GW 1005 to initially configure the NFEF of C/M plane 1003 for enabling D-User 1012 to interact with the NFEF of C/M plane 1003 and manage the network feature (i.e., traffic management). MMaaS 1008 may also request network state information, which may include without limitation, network topology, DPF and data gateway loading, QoS status per data gateway, resource cost, and the like. Upon completion of the NFEF configuration, NET4CON C/M GW 1003 may send an acknowledgment message 1029 to MMaaS 1008 which may include the network state information.

MMaaS 1008 may then send network state information to D-User C/M plane 1013 with message 1030.

D-User 1012 may then set up session parameters for NFEF of C/M plane 1003, serving NET4CON data gateways 1004, and DPFs (not shown) according to the combined policy rules set up by D-User PLF 1016, as illustrated by block 1031. For example, D-User 1012 may provide session parameters to MMaaS 1008, which then forwards the session parameters to NET4CON C/M 1003 through NET4CON C/M gateway 1005, which then sets the parameters for the NFEF of C/M plane 1003 and NET4CON data gateways 1004 based on the received session parameters. Alternatively, the D-User may provide the session parameters directly to the NFEF of C/M plane 1003 and NET4CON data gateways 1004. In at least some embodiments, NFEF of C/M plane 1003 may receive the session parameters and translate them to a format which is understandable by a network element responsible for managing the relevant feature. The NFEF of C/M plane 1003 may then provide the translated parameters to that network element.

MMaaS 1008 may then respond to request 1022 acknowledging the establishment of a UCM session with message 1032, and NET4CON C/M gateway 1005 may respond to request 1020 with message 1033 to P-User 1001 acknowledging the establishment of the UCM session.

Message 1033 may comprise packet header formatting information, such that when P-User 1001 sends packets with corresponding packet headers, these packets will be treated according to the session parameters. The packet header formatting information may comprise a UCM session identifier, or a feature identifier.

Upon P-User 1001 receiving message 1033, P-User 1001 may then send and receive data packets using the established session in which traffic management complies with the policies set by D-User 1011.

Reference is now made to FIG. 11, in which a method for D-User configuration, corresponding to block 1026 of FIG. 10, is illustrated. D-User configuration may be triggered by a Mission Management Service C/M and involves D-User functions such as, without limitation, TFMF and DPF being set up by the D-User. D-User functions may be configured based on D-User policies managed by the D-User PLF and the session rules set by the Service Provisioning Management service.

As seen in FIG. 11, MMaaS 1101 sends a request 1110 to D-User 1105 though D-User C/M 1106, corresponding to request 1025 from FIG. 10. D-User C/M 1106 may then forward request 1110 to TFMF 1107 as message 1111, to create a session context. Message 1111 may include session-related information (e.g., QoS info., usage reporting, and the like) retrieved from the SPMaaS (not shown). TFMF 1107 is responsible for managing traffic inside D-User 1105 as well as in the network, in coordination with the NFEF (not shown).

Upon creating the session context, TFMF 1107 sends request 1112 to PLF 1109 for the preparation of the UCM session policy. Request 1112 may include, without limitation, policy rules retrieved from the SPMaaS, data gateway IDs, reporting capability of the NFEF, and the like.

Upon receiving request 1112, D-User PLF 1109 may first retrieve its own policy stored in its database and then create the UCM session policy based on the retrieved policy and the session policy information retrieved from the SPMaaS. The UCM session policy may include QoS-related rules, billing-related rules, reporting-related rules, packet forwarding-related rules, and the like.

PLF 1109 may then send message 1114 to TFMF 1107 as a response to request 1112. Message 1114 may include, without limitation, the policy rules prepared by PLF 1109, and a policy ID. Upon receiving message 1114, TFMF 1107 configures D-User DPF 1108 according to policy rules received from PLF 1109, as illustrated by block 1115.

Upon configuring D-User DPF 1108, TFMF 1107 may send message 1116 to D-User C/M 1106 to acknowledge the creation of the session context. Message 1116 may then be forwarded to NET4DW C/M 1104, and ultimately to MMaaS, corresponding to message 1027 from FIG. 10.

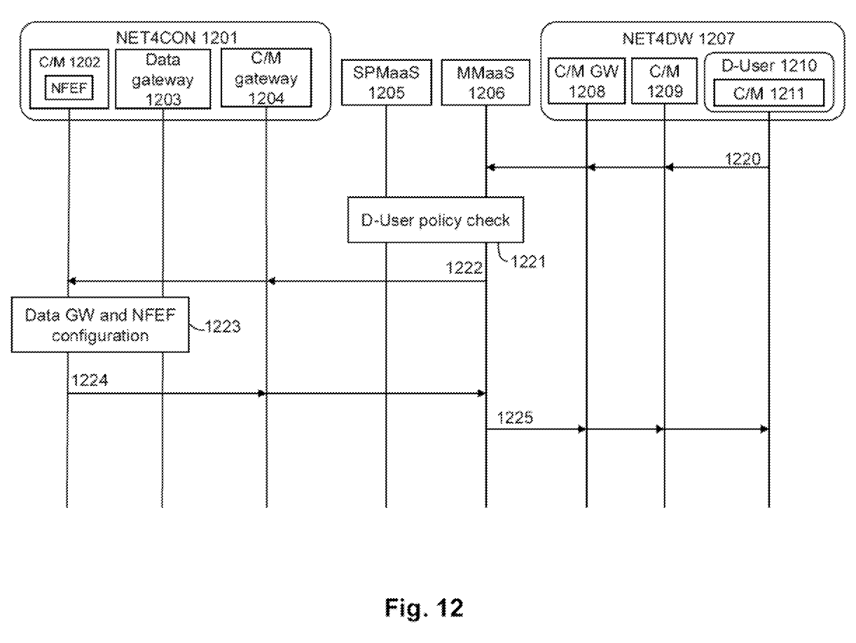

Reference is now made to FIG. 12, in which a method for configuring an NFEF and a data gateway, corresponding to block 1031 of FIG. 10, is illustrated.

As seen in FIG. 12, D-User 1210 sends message 1220 to MMaaS 1206. Message 1220 may include NFEF and data gateway configuration parameters as determined by the D-User PLF (not shown), including without limitation: (1) information identifying the UCM service, the requested feature, the network function to be controlled, and the D-User, such as a UCM service ID, a requested feature ID, a D-User ID, data gateway IDs, and DPF IDs; (2) traffic routing information for each NET4CON data gateway, such as routing tables, packet filtering rules, packet buffering rules, packet priority, packet inspection rules, and packet redirection rules; (3) data processing information for each DPF, such as DPF IDs, processing type ID, data identifier (e.g., ID, location, and the like), and a target of processing results reporting; and (4) QoS information for each NET4CON data gateway, such as packet delay and data rate.

Upon receiving message 1220, MMaaS 1206 requests that SPMaaS 1205 authorize the configuration parameters received from D-User 1210, as illustrated by block 1221.

Upon validating the configuration parameters, MMaaS 1206 may send the NFEF and data gateway configuration parameters to NET4CON C/M 1202 through NET4CON C/M gateway 1204 in message 1222.

Upon receiving message 1222, NET4CON C/M 1202 may forward the configuration parameters to NFEF of C/M plane 1202. NFEF of C/M plane 1202 and data gateway 1203, may then apply the configuration parameters, as illustrated by block 1223. Then, NET4CON C/M 1202 may acknowledge the completion of the NFEF and data gateway configuration with message 1224 to MMaaS 1206. Upon receiving message 1224, MMaaS 1206 may acknowledge the completion of the NFEF and data gateway configuration with message 1225 to D-User 1210.

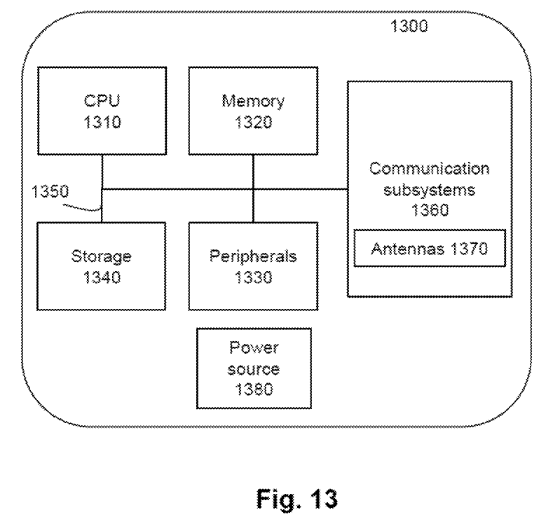

The above functionality may be implemented on any one or combination of computing devices. FIG. 13 is a block diagram of a computing device 1300 that may be used for implementing the devices and methods disclosed herein. Specific devices may utilize all of the components shown, or only a subset of the components, and levels of integration may vary from device to device. Furthermore, a device may contain multiple instances of a component, such as multiple processing units, processors, memories, transmitters, receivers, etc. The computing device 1300 may comprise a central processing unit (CPU) 1310, memory 1320, a mass storage device 1340, and peripherals 1330. Peripherals 1330 may comprise, amongst others one or more input/output devices, such as a speaker, microphone, mouse, touchscreen, keypad, keyboard, printer, display, network interfaces, and the like. Communications between CPU 1310, memory 1320, mass storage device 1340, and peripherals 1330 may occur through one or more buses 1350.

Computing device 1300 may comprise a communications subsystem 1360 for communicating with other devices across communication networks. Communications subsystem 1360 may include one or more antennae 1370 for wireless communications.

The bus 1350 may be one or more of any type of several bus architectures including a memory bus or memory controller, a peripheral bus, video bus, or the like. The CPU 1310 may comprise any type of electronic data processor. The memory 1320 may comprise any type of system memory such as static random-access memory (SRAM), dynamic random-access memory (DRAM), synchronous DRAM (SDRAM), read-only memory (ROM), a combination thereof, or the like. In an embodiment, the memory 1320 may include ROM for use at boot-up, and DRAM for program and data storage for use while executing programs.

The mass storage device 1340 may comprise any type of storage device configured to store data, programs (e.g. instructions or code), and other information and to make the data, programs, and other information accessible via the bus. The mass storage device 1340 may comprise, for example, one or more of a solid-state drive, hard disk drive, a magnetic disk drive, an optical disk drive, or the like. The memory 1320 or mass storage 1340 may store instructions, which when executed by a processor or processing unit, cause or configure the computing device 1300 to perform any of the methods described herein.

The computing device 1300 may also include one or more network interfaces (not shown), which may comprise wired links, such as an Ethernet cable or the like, and/or wireless links to access nodes or different networks. The network interface allows the processing unit to communicate with remote units via the networks. For example, the network interface may provide wireless communication via one or more transmitters/transmit antennas and one or more receivers/receive antennas. In an embodiment, the processing unit is coupled to a local-area network or a wide-area network, for data processing and communications with remote devices, such as other processing units, the Internet, remote storage facilities, or the like.

Through the descriptions of the preceding embodiments, the teachings of the present disclosure may be implemented by using hardware only or by using a combination of software and hardware. Software or other computer executable instructions for implementing one or more embodiments, or one or more portions thereof, may be stored on any suitable computer readable storage medium. The computer readable storage medium may be a tangible or in non-transitory medium such as optical (e.g., CD, DVD, Blu-Ray, etc.), magnetic, hard disk, volatile or non-volatile, solid state, or any other type of storage medium known in the art.

Additional features and advantages of the present disclosure will be appreciated by those skilled in the art.

The structure, features, accessories, and alternatives of specific embodiments described herein and shown in the Figures are intended to apply generally to all of the teachings of the present disclosure, including to all of the embodiments described and illustrated herein, insofar as they are compatible. In other words, the structure, features, accessories, and alternatives of a specific embodiment are not intended to be limited to only that specific embodiment unless so indicated.

Moreover, the previous detailed description is provided to enable any person skilled in the art to make or use one or more embodiments according to the present disclosure. Various modifications to those embodiments will be readily apparent to those skilled in the art, and the generic principles defined herein may be applied to other embodiments without departing from the spirit or scope of the teachings provided herein. Thus, the present methods, systems, and or devices are not intended to be limited to the embodiments disclosed herein. The scope of the claims should not be limited by these embodiments, but should be given the broadest interpretation consistent with the description as a whole. Reference to an element in the singular, such as by use of the article "a" or "an" is not intended to mean "one and only one" unless specifically so stated, but rather "one or more". All structural and functional equivalents to the elements of the various embodiments described throughout the disclosure that are known or later come to be known to those of ordinary skill in the art are intended to be encompassed by the elements of the claims.

Furthermore, nothing herein is intended as an admission of prior art or of common general knowledge. Furthermore, citation or identification of any document in this application is not an admission that such document is available as prior art, or that any reference forms a part of the common general knowledge in the art. Moreover, nothing disclosed herein is intended to be dedicated to the public regardless of whether such disclosure is explicitly recited in the claims.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A method at a network element of a network, comprising:
receiving, from a user equipment (UE), a first request for establishing a user controlled and managed (UCM) service, wherein the UCM service allows the UE to control at least one feature of a UCM session of the UCM service using a control plane function of the UCM service;
retrieving a first policy for the UE from a policy function of the network, the first policy indicating network requirements for controlling the at least one feature of the UCM session of the UCM service;
sending a second request to a digital user (D-User), the second request being based on the first policy, wherein the D-User is a digital representative of the UE hosted by the network;
receiving from the D-User, session parameters, wherein the session parameters are based on the second request and a policy function of the D-User; and
configuring a network function based on the session parameters, the network function comprising at least one of a network feature exposure function (NFEF), a data processing function (DPF), a user plane function (UPF), or a data gateway.

2. The method of claim 1, wherein the configuring comprises:
providing the session parameters to a second network element.

3. The method of claim 1, wherein the configuring comprises:
providing the session parameters to the NFEF, wherein the NFEF translates the session parameters to parameters understandable by a second network element responsible for managing the at least one feature of the UCM session of the UCM service.

4. The method of claim 1, wherein the at least one feature of the UCM session of the UCM service comprises traffic management.

5. The method of claim 1, wherein the at least one feature comprises one of selecting a low power channel, selecting a low interference channel, providing a high priority channel, or applying multiple-input multiple output (MIMO).

6. The method of claim 1, wherein the network is one of a radio access network (RAN), a core network (CN), a transport network (TN), or a data network (DN).

7. The method of claim 4, wherein the session parameters comprise at least one of traffic routing information for the data gateway, packet filtering rules, packet buffering rules, packet priority, packet inspection rules, and packet redirection rules, and wherein the network function comprises at least one of the DPF, the UPF, or the data gateway.

8. The method of claim 1, wherein the session parameters are selected to be applied to different nodes of the network.

9. The method of claim 1, wherein the first request comprises at least one of a UE identifier, a D-User identifier, a UCM service identifier, or a data gateway identifier.

10. The method of claim 4, wherein the first policy comprises at least one of packet forwarding rules, packet inspection rules, Quality of Service (QoS) handling, data processing rules, reporting rules, network feature selection rules, or billing rules.

11. The method of claim 1, further comprising, prior to receiving the session parameters:
sending a third request to the NFEF for network state information; and
receiving the network state information from the NFEF.

12. The method of claim 11, further comprising:
upon receiving the network state information, forwarding the network state information to the D-User.

13. The method of claim 11, wherein the network state information comprises a level of network information exposure, the level of network information exposure comprising one of traffic path information, end-to-end path information, or abstracted virtual network topology.

14. The method of claim 1, further comprising:
sending, to the UE, a response to the first request, the response confirming establishment of the UCM session and comprising packet header formatting information.

15. The method of claim 14, wherein the packet header formatting information comprises at least one of a UCM session identifier or a feature identifier.

16. The method of claim 1, wherein the configuring comprises:
configuring the network function to divert UCM session traffic to a DPF of the D-User, wherein the DPF of the D-User is configured to process the UCM session traffic according to a D-User policy and a processing specification within packet headers of the UCM session traffic.

17. The method of claim 1, wherein the configuring the network function comprises:
configuring the network function to apply the at least one feature to UCM session traffic according to the session parameters.

18. The method of claim 1, wherein the configuring the network function comprises:
preparing the network function to apply the session parameters to session traffic arriving at the network function.

19. A network element comprising:
one or more processors; and
a non-transitory computer readable storage medium storing instructions that, when executed by the one or more processors, cause the network element to:
receive, from a user equipment (UE), a first request for establishing a user controlled and managed (UCM) service, wherein the UCM service allows the UE to control at least one feature of a UCM session of the UCM service using a control plane function of the UCM service;
retrieve a first policy for the UE from a policy function of a network, the first policy indicating network requirements for controlling the at least one feature of the UCM session of the UCM service;
send a second request to a digital user (D-User), the second request being based on the first policy, wherein the D-User is a digital representative of the UE hosted by the network;
receive from the D-User, session parameters, wherein the session parameters are based on the second request and a policy function of the D-User; and
configure a network function based on the session parameters, the network function comprising at least one of a network feature exposure function (NFEF), a data processing function (DPF), a user plane function (UPF), or a data gateway.

20. A non-transitory computer readable storage medium having stored thereon computer readable instructions, which when executed by a network element of a network, cause the network element to:
receive, from a user equipment (UE), a first request for establishing a user controlled and managed (UCM) service, wherein the UCM service allows the UE to control at least one feature of a UCM session of the UCM service using a control plane function of the UCM service;
retrieve a first policy for the UE from a policy function of the network, the first policy indicating network requirements for controlling the at least one feature of the UCM session of the UCM service;
send a second request to a digital user (D-User), the second request being based on the first policy, wherein the D-User is a digital representative of the UE hosted by the network;
receive from the D-User, session parameters, wherein the session parameters are based on the second request and a policy function of the D-User; and
configure a network function based on the session parameters, the network function comprising at least one of a network feature exposure function (NFEF), a data processing function (DPF), a user plane function (UPF), or a data gateway.
